(19) United States
(12) Patent Application Publication
(10) Pub. No.: US 2010/0064656 A1
(43) Pub. Date: Mar. 18, 2010

(54) ENGINES AND METHODS OF OPERATING THE SAME

(75) Inventors: David Andrew Lopez, Gilbert, AZ (US); Tom Elliott, Chandler, AZ (US); Kendall Keith Dalton, Mesa, AZ (US); Craig E. Thompson, Gilbert, AZ (US); Dale Mukavetz, Chandler, AZ (US); Joseph S. Howard, III, Chandler, AZ (US); John Harvell, Kamby, IN (US); Dana Metz, Gilbert, AZ (US); Leonard J. Meyer, Mesa, AZ (US); Michael Tate, Chandler, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/233,368

(22) Filed: Sep. 18, 2008

(51) Int. Cl. F02C 9/20; F01D 9/02; F02C 9/00

(52) U.S. Cl. 60/39.24; 60/772; 415/148

(57) ABSTRACT

Engines and methods for operating the engines are provided. The engine includes a means for limiting overspeed in flow communication with a turbine section flowpath, wherein the means for limiting overspeed is adapted to block a first portion of an airflow received along a first direction vector from flowing into an exhaust section flowpath and to redirect a second portion of the airflow received along the first direction vector or a portion of the blocked first portion of the airflow to flow along another direction vector that is closer to parallel with a longitudinal axis than the first direction vector.

### TECHNICAL FIELD

The inventive subject matter generally relates to engines, and more particularly relates to apparatus and methods of operating engines.

### BACKGROUND

A turboshaft turbine engine may be used to power various components of an aircraft, such as a propeller of a helicopter or a turboprop airplane. Typically, the turboshaft turbine engine includes, for example, an intake section, a compressor section, a combustor section, and a turbine section, and each section may include one or more components mounted to a common shaft. The turboshaft turbine engine may also include an exhaust section that is located downstream from the turbine section.

Generally, the intake section induces air from the surrounding environment into the engine and accelerates the air toward the compressor section. The compressor section, which may include one or more compressors, raises the pressure of the air it receives from the intake section to a relatively high level. The compressed air then enters the combustor section, where a ring of fuel nozzles injects a steady stream of fuel into a plenum. The injected fuel is ignited to produce high-energy compressed air. The air then flows into and through the turbine section to impinge upon turbine blades therein to rotate the shaft. The shaft may be coupled to a propeller or other component, with or without an intervening speed reduction gearbox, and may provide energy for propulsion thereof. The air exiting the turbine section may be exhausted from the engine via the exhaust section.

At times, the engine may experience a loss of load absorption, which may lead to an overspeed condition. In such case, airflow from the combustor section may produce a load upon a turbine that could accelerate the turbine beyond a predetermined maximum operating speed. To minimize the magnitude of the overspeed condition, an electrical system coupled to the engine may cease supplying fuel to the combustor section to decrease the energy and to slow the velocity of the airflow therefrom. However, additional or alternative means of limiting overspeed conditions may be desired in some circumstances.

Accordingly, there is a need for system engine features that minimizes the magnitude of an overspeed condition. It is desirable for such improvements to be capable of being retrofitted into existing turboshaft turbine engines. Additionally, it is desirable for such improvements to be relatively inexpensive to implement into turboshaft turbine engines. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Engines and methods for operating the engines are provided.

In an embodiment, by way of example only, an engine includes a turbine rotor adapted to rotate about a longitudinal axis and to at least partially define a turbine section flowpath including the longitudinal axis extending therethrough, wherein the turbine rotor includes a plurality of turbine rotor blades adapted to direct an airflow through the turbine section flowpath along a first direction vector when the turbine rotates below a first threshold speed, and along a second direction vector when the turbine rotates above a second threshold speed, wherein the first direction vector has a positive angular offset from the longitudinal axis, and the second direction vector has a first negative angular offset from the longitudinal axis. The engine also includes an exhaust section adapted to receive the airflow from the turbine section flowpath, the exhaust section defining an exhaust section flowpath. The engine further includes a means for limiting overspeed in flow communication with the turbine section flowpath, wherein the means for limiting overspeed is adapted to block a first portion of the airflow received along the first direction vector from flowing into the exhaust section flowpath and to redirect a second portion of the airflow received along the first direction vector or a portion of the blocked first portion of the airflow to flow along a third direction vector that is closer to parallel with the longitudinal axis than the first direction vector.

In another embodiment, by way of example only, a method includes rotating a turbine rotor at a rotational speed about a longitudinal axis, directing an airflow through the turbine section flowpath along a first direction vector when the turbine rotates below a first threshold speed, wherein the first direction vector has a positive angular offset from the longitudinal axis, re-directing substantially all of the airflow flowing along the first direction vector to flow through an exhaust section flowpath along a second direction vector that is closer to parallel with the longitudinal axis than the first direction vector, directing an airflow through the turbine section flowpath along a third direction vector when the turbine rotates above a second threshold speed, the third direction vector having a first negative angular offset from the longitudinal axis, and blocking at least a portion of the airflow flowing along the third direction vector from flowing into the exhaust section flowpath.

### BRIEF DESCRIPTION OF THE DRAWINGS

The inventive subject matter will hereinafter be described in conjunction with the following drawing figures, wherein like numerals denote like elements, and

FIG. 1 is a simplified, cross-sectional view of an engine, according to an embodiment;

FIG. 2 is a close up, simplified top view taken along line 2-2 in FIG. 1 of an interior of a turbine section and an exhaust section of an engine depicting airflow therethrough during a first operating condition, according to an embodiment;

FIG. 3 is a close up, simplified top view taken along line 2-2 in FIG. 1 of an interior of a turbine section and an exhaust section of an engine depicting airflow therethrough during a second operating condition, according to an embodiment;

FIG. 4 and FIG. 5 are a close up, simplified top view taken along line 2-2 in FIG. 1 of an interior of a turbine section and an exhaust section of an engine, according to another embodiment; and

FIG. 6 is a flow diagram depicting a method of operating an engine, according to an embodiment.

### DETAILED DESCRIPTION

The following detailed description is merely exemplary in nature and is not intended to limit the inventive subject matter or the application and uses of the inventive subject matter. In particular, although the inventive subject matter is described as being implemented as part of a turboshaft turbine engine, it will be appreciated that an inventive subject matter may alternatively be incorporated into turboprop engines, or any other types of devices in which an air brake may be useful. Furthermore, there is no intention to be bound by any theory presented in the preceding background or the following detailed description.

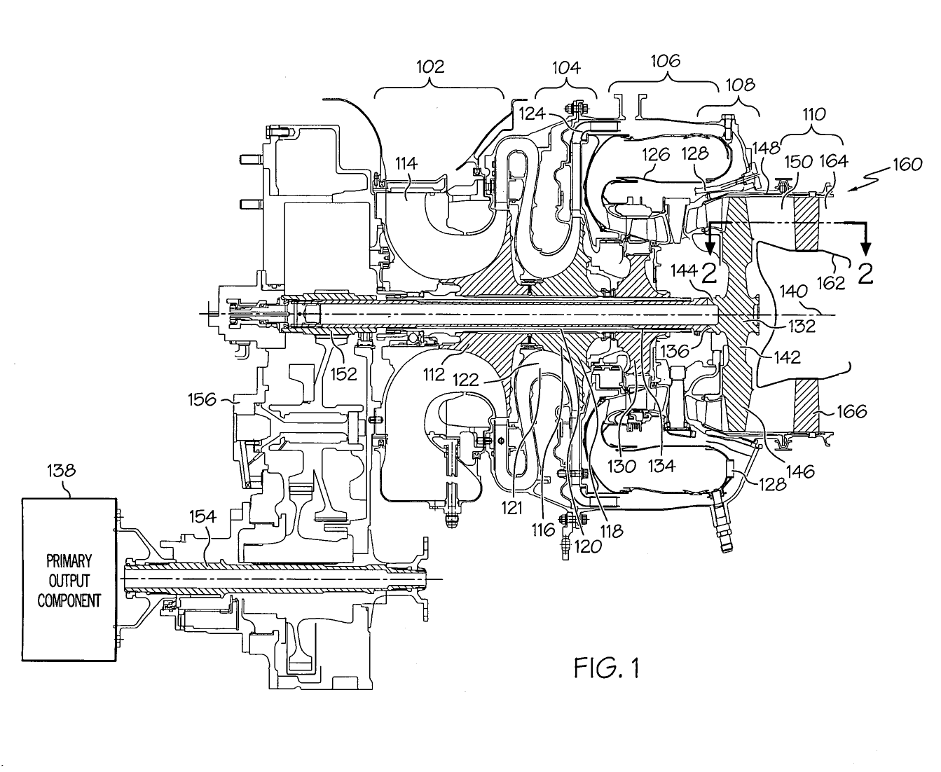

FIG. 1 is a simplified, cross-sectional view of an engine 100, according to an embodiment. The engine 100 may be a turboshaft turbine engine, in an embodiment. In another embodiment, the engine 100 may be another type of engine in which a brake, which employs surrounding air or fluids for a braking action, may be useful. In any case, the engine 100 may generally include an intake section 102, a compressor section 104, a combustor section 106, a turbine section 108, and an exhaust section 110. The intake section 102 draws air into an airflow inlet 114 and accelerates the air into the compressor section 104.

The compressor section 104 includes a compressor 116 that raises the pressure of the air directed into it from the intake section 102. As shown in FIG. 1, the compressor section 104 may be a two-stage compressor 112, 116, however other types of compressors may alternatively be used. One or both of the compressors 112, 116 may include an impeller 118 that is mounted to a compressor shaft 120 and that is surrounded by a shroud 121 to define a compressor section flowpath 122. Although two compressors 112, 116 are shown, more compressors may be included in other embodiments. In an embodiment, the high pressure air may be directed into the combustor section 106 by a diffuser 124. The diffuser 124 may diffuse the high pressure air for more uniform distribution thereof into the combustor section 106. In an embodiment, the combustor section 106 may include an annular combustor 126, which receives the diffused air. One or more fuel nozzles 128 may supply fuel to the annular combustor 126, and the high pressure air is mixed with fuel and combusted therein. The combusted air is then directed into the turbine section 108.

The turbine section 108 may include an intermediate turbine 130 and a power turbine 132 disposed in axial flow series. The combusted air from the combustor section 106 expands through the turbines 130, 132 causing each to rotate. As each turbine 130, 132 rotates, each drives equipment in the engine 100 via concentrically disposed shafts or spools. For example, the intermediate turbine 130 may drive the compressor 116 via an intermediate shaft 134, which is coupled to the compressor shaft 120, in an embodiment. In another embodiment, the power turbine 132 includes a turbine rotor 136 that drives a primary output component 138, such as a propeller. In such case, the turbine rotor 136 may be adapted to rotate about a longitudinal axis 140 (e.g., engine centerline) and may include a hub 142 that is coupled to a turbine rotor shaft 144. The hub 142 may also include a plurality of turbine blades 146 extending radially outwardly. The turbine blades 146 may be surrounded by a portion of an engine case 148 to define a turbine section flowpath 150 through which the longitudinal axis 140 extends. The hub 142 and the turbine blades 146 act as a load upon which combusted air received by the turbine section flowpath 150 may provide a torque to rotate the turbine rotor shaft 144. The turbine rotor shaft 144 may be coupled to a main shaft 152 that, in turn, is coupled to a primary output shaft 154 to which the primary output component 138 is mounted. For example, a gearbox assembly 156 may couple the primary output shaft 154 and the main shaft 152 to each other.

After the air travels through the turbine section 108, it is then exhausted through the exhaust section 1 10. The exhaust section 110 may include an exhaust nozzle assembly 160 to direct the air in a desired direction. In an embodiment, the exhaust nozzle assembly 160 may include a centerbody 162 disposed adjacent to and downstream from the power turbine 132. The centerbody 162 may be held in place by struts (not shown) and may extend into an exhaust section flowpath. 164. A plurality of exit guide vanes 166 may extend radially outwardly from the centerbody 162 and into the exhaust section flowpath 164. In an embodiment, the exit guide vanes 166 include airfoils designed to turn the air flow through the exhaust section flowpath 164 to thereby remove a tangential swirl component therefrom such that the air flows along the longitudinal axis 140.

In an embodiment, the engine 100 is configured to operate in a normal operating mode. A “normal operating mode,” as used herein, may be defined, in part, as a mode during which the engine 100 is in operation and the power turbine 132 is rotating below a first threshold speed. In an embodiment, the first threshold speed may be a speed that is within a particular percentage of a design speed at which the power turbine 132 may be designed to rotate. In some embodiments, the design speed may be in a range of 37,000 rotations per minute to 47,000 rotations per minute. In other embodiments, the design speed may be slower or faster than the aforementioned range. In an embodiment, the first threshold speed may be in a range of about 100% to about 110% of the design speed. In other embodiments, the first threshold speed may be more or less than the aforementioned range, and the particular threshold speed may depend on a size and design of the engine 100. The normal operating mode may include a wide range of conditions from idle to maximum power.

In the event of a sudden loss of load on the engine 100, the engine 100 may operate in an overspeed condition. An “overspeed condition,” as used herein, may be defined, in part, as a mode during which the engine 100 is in operation and the power turbine 132 is rotating above a second threshold speed. The second threshold speed is above the design speed, in an embodiment. In another embodiment, the second threshold speed is more than the first threshold speed. In an example, the second threshold speed is substantially more than (e.g., ±1000 rpm) the first threshold speed. In yet another embodiment, the second threshold speed may be greater than about 110% of the design speed. In still other embodiments, the second threshold speed may be above 130% of the design speed.

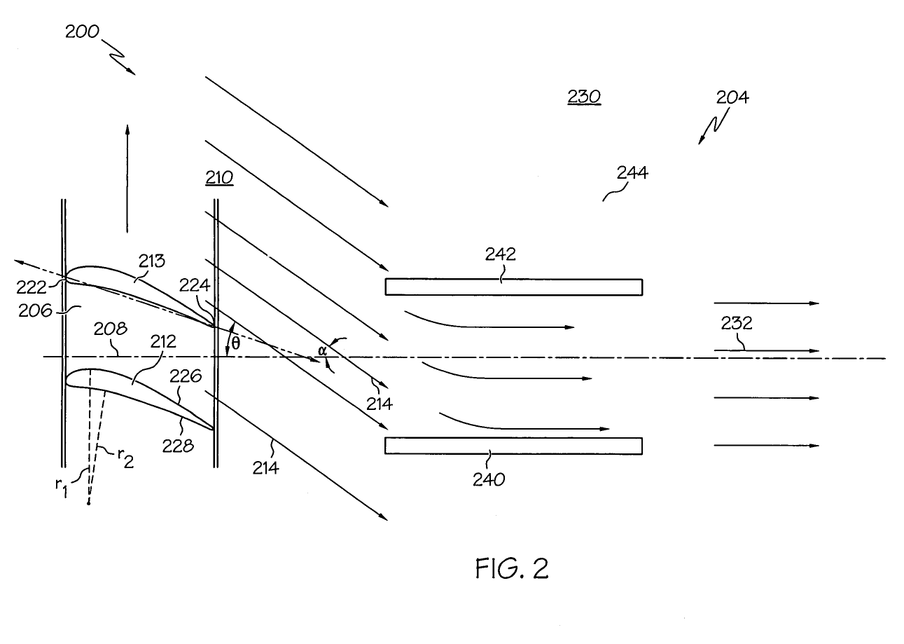

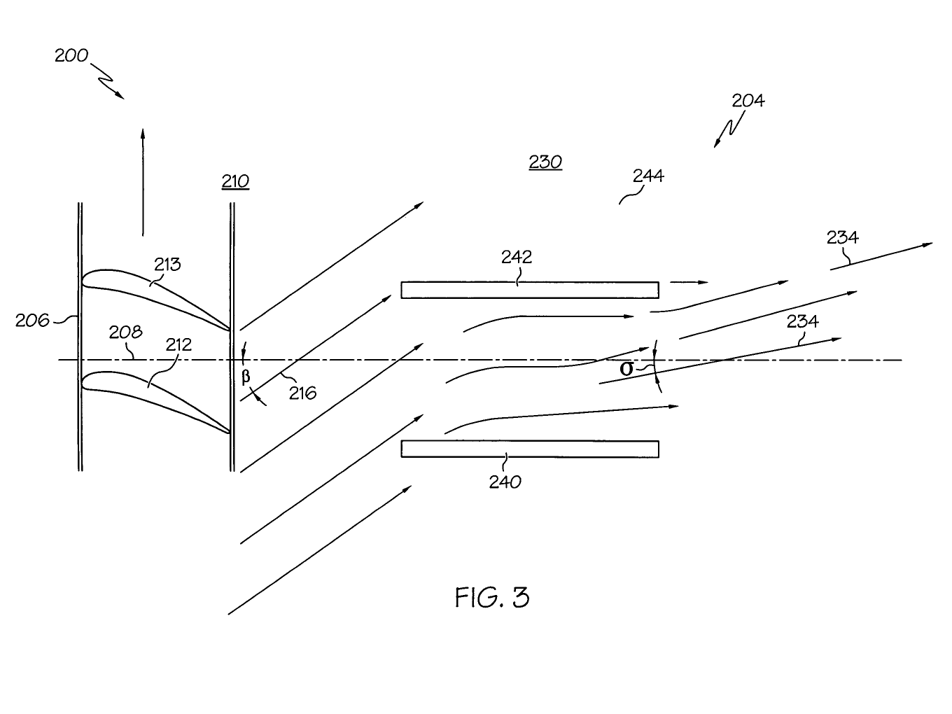

To decrease a magnitude of or limit the overspeed condition, a passive, aerodynamic overspeed protection mechanism may be implemented between the turbine section 108 and the exhaust section 110. With reference to both FIGS. 2 and 3, close up, simplified, top views taken along line 2-2 in FIG. 1 of an interior of a turbine section 200 and an exhaust section 204 of an engine are provided depicting airflow therethrough during a first operating condition (FIG. 2) and during a second operating condition (FIG. 3), according to an embodiment. In an embodiment, the first operating condition may be the normal operating mode, and the second operating condition may be the overspeed condition.

According to an embodiment, the overspeed protection mechanism includes a turbine rotor 206 and a means for limiting overspeed. The turbine rotor 206 rotates about a longitudinal axis 208 and includes a plurality of turbine rotor blades 212, 213, only two of which are illustrated in FIGS. 2 and 3. In an embodiment, the turbine rotor blades 212, 213 may be adapted to direct an airflow through the turbine section flowpath 210 along a first direction vector 214 (FIG. 2) while under the first operating condition (e.g., such as when the turbine rotor 206 rotates below the first threshold speed), where the first direction vector 214 may have a positive angular offset (“α”) from the longitudinal axis 208 (shown in FIG. 2), and along a second direction vector 216 (FIG. 3) while under the second operating condition (e.g., such as when the turbine rotor 206 rotates above the second threshold speed), where the second direction vector 216 has a first negative angular offset (“β”) from the longitudinal axis 208 (shown in FIG. 3).

As noted above and as shown in FIG. 2, the first direction vector 214 represents a direction in which a majority of the airflow may flow while under the first operating condition. In an embodiment, the positive angular offset (“α”) of the first direction vector 214 may be in a range of from about 20 degrees to about 30 degrees. In another embodiment, the positive angular offset (“α”) of the first direction vector 214 may be less or more than the aforementioned range. To direct the airflow along the first direction vector 214, the pressure side walls 228 of the turbine rotor blades 212, 213 may be disposed at an angle, or “blade offset angle (“θ”)”, relative to the longitudinal axis 208, in an embodiment. For example, a blade axis 220 extending from a tip 222 thereof to a trailing edge 224 may have a blade offset angle (“θ”) in a range of from about 25 degrees to about 45 degrees_. In another embodiment, the blade offset angle (“θ”) may be substantially equal to (e.g., ±1°) the positive angular offset (“α”) of the first direction vector 214. The blade offset angle (“θ”) may be greater or less than the aforementioned range provided for the positive angular offset (“α”), in another embodiment. In any event, the particular blade offset angle (“θ”) may depend on an intended gas flow velocity through the engine (e.g., engine 100).

A particular configuration of blades 212, 213 may depend on a particular axial length and, in some embodiments, a curvature radius of walls of the blade 212, 213. For example, a blade 212, 213 may be cambered (e.g., curved) and may include a convex, suction side wall 226 and/or a concave, pressure side wall 228. The blade 212, 213 may have an axial length in a range of from about 0.5 inch (1.27 cm) to about 2.0 inches (5.08 cm), a curvature radius (r₁) of the suction side wall 226 in a range of from about 1 inches (2.54 cm) to about 4 inches (10.16 cm), and a curvature radius (r₂) of the pressure side wall 228 in a range of from about 2 inches (5.08 cm) to about 5 inches (12.07 cm). In other embodiments, the axial lengths and curvature radii may be greater or less. Additionally, the blades 212, 213 may have a varying width along its axial length, or may have a substantially uniform width (e.g., within ±0.5 mm) along its axial length. In either case, the widths may be within a range of from about 0.2 inch (0.51 cm) to about 0.5 inch (1.27 cm), in an embodiment. In other embodiments, the widths may be less or more. Although the turbine rotor blades 212, 213 are shown as being cambered, they may alternatively be straight vanes, in other embodiments.

Spacing between adjacent blades 212, 213 may also be designed to direct the airflow along the first direction vector 214. In an embodiment, the blades 212, 213 may be disposed substantially uniformly (e.g., within ±0.5 mm of a separation distance) around a circumference of the turbine rotor 206, and a particular separation distance there between may depend on a size of the particular turbine rotor 206 and the number of total blades 212, 213 included. In one example, the rotor 206 may include a hub 230 that has a diameter in a range of between about 3.0 inches (7.62 cm) to about 4.0 inches (10.16 cm). In such case, between about twenty-four and about thirty blades 212, 213 may be included around the hub 230, and a separation distance in a range of between about 0.5 inch (1.27 cm) to about 1 inch (2.54 cm) may be designed between the blades 212, 213. Although two blades 212, 213 are shown in FIGS. 2 and 3, it will be appreciated that more blades 212, 213 may be included, and the separation distance between the blades 212, 213 may be greater or less than the above given range, in other embodiments. Moreover, although adjacent turbine rotor blades 212, 213 are shown as having substantially the same configurations and dimensions, other embodiments may include turbine rotor blades 212, 213 having varying configurations and dimensions.

As alluded to above and shown in FIG. 3, the second direction vector 216 represents a direction in with a majority of the airflow may flow while under the second operating condition. In an embodiment in which the second operating condition is the overspeed condition, the first negative angular offset (“β”) of the second direction vector 216 may not necessarily be a predetermined value. However, in any case, the second direction vector 216 is offset relative to the longitudinal axis 208 at an angle within a range of from about −30 degrees to about −45 degrees. In another embodiment, the first negative angular offset (“β”) of the second direction vector 216 may be less or more than the aforementioned range.

In an embodiment, the means for limiting overspeed is disposed in flow communication with the turbine section 210 and is adapted to block at least a portion of the area through which airflow passes into the exhaust section flowpath 230 during overspeed operating conditions. In one example, flow separation and recirculation of the airflow around one side of the guide vane redirects the airflow (i.e., straightens the airflow) to thereby flow through the exhaust section flowpath 230 in a desired direction. Because the area of the flowpath available for the airflow to travel is restricted as it is redirected and straightened, excess pressure in the airflow is dissipated. This pressure dissipation reduces torque produced by the turbine rotor to limit overspeed.

In another embodiment, the re-directing means (guide vanes 240 and 242) may be adapted to affect an angle of the airflow as it exits the exhaust section flowpath 230. For example, the guide vanes may be further adapted to redirect another portion of airflow received along the first direction vector 214 (e.g., unblocked airflow from the turbine section 210) and/or to redirect a portion of the air to flow along a third direction vector 232 that is closer to being parallel with the longitudinal axis 208 than the first direction vector 214. In an embodiment, the third direction vector 232 may be substantially parallel to the longitudinal axis 208. In another example, the guide vanes may be still further adapted to redirect another portion of airflow received along the second direction vector 216 to flow along a fourth direction vector 234, wherein the fourth direction vector 234 has a second negative angular offset (“σ”) from the longitudinal axis 208 that is smaller than the first negative angular offset (“β”) of the second direction vector 216.

The means for limiting overspeed may be implemented in any one of numerous manners in which at least a portion of the airflow is blocked from entry into the exhaust section flowpath 230. For example, in an embodiment, the means for limiting overspeed may include a plurality of exit guide vanes 240, 242 that extend radially outwardly from a center body 244 into the exhaust section flowpath 230. The exit guide vanes 240, 242 may be disposed at a particular distance downstream from the turbine rotor blades 212, 213 and may be spaced substantially uniformly (e.g., within ±0.5 mm) around the center body 244, in an embodiment. The particular distance from the turbine rotor blades 212, 213, the spacing between adjacent exit guide vanes 240, 242 may depend on an axial length of the guide vanes 240, 242 and the number of guide vanes 240, 242 disposed around the center body 244.

The aforementioned dimensions are selected to provide a configuration capable of allowing substantially all of the air from the turbine section flowpath 210 to impinge upon at least a portion of one or more of the exit guide vanes 240, 242. Generally, in this regard, exit guide vanes having longer axial lengths may be disposed further away from the turbine rotor blades and/or or may be spaced wider apart than exit guide vanes that have shorter axial lengths. Additionally, fewer exit guide vanes having longer lengths may be used in an embodiment, while more exit guide vanes having shorter lengths may be used in other embodiments. In an example, between twelve and twenty-four exit guide vanes 240, 242 may be included around a center body 244 having a diameter in a range of 2 inches (5.08 cm) to about 3 inches (7.62 cm), and the exit guide vanes 240, 242 may have axial lengths in a range of from about 1 inch (2.54 cm) to about 3 inches (7.62 cm), a spacing between the vanes 240, 242 in a range of from about 0.5 inch (1.27 cm) to 1.5 inches (3.81 cm), and a distance from the trailing edge 224 of the turbine rotor blades 212, 213 to the guide vanes 240, 242 in a range of from about 0.5 inch (1.27 cm) to about 2.5 inches (6.35 cm). Although two exit guide vanes 240, 242 are illustrated in FIGS. 2 and 3, it will be understood that more may be included in other embodiments. Additionally in other embodiments, the dimensions of the center body 244 and the exit guide vanes 240, 242 and spacing may be greater or less than the aforementioned range.

Each exit guide vane 240, 242 may be a straight vane, in an embodiment, and each may have a substantially uniform width (e.g., within ±0.5 mm) along its axial length. For example, each width may be within a range of from about 0.05 inch (0.13 cm) to about 0.1 inch (0.25 cm), in an embodiment. In other embodiments, the widths may be less or more. Although adjacent exit guide vanes 240, 242 are shown as having substantially the same configurations and as being disposed at substantially the same distance from the trailing edge 224 of the turbine rotor blades 212, 213, other embodiments may include exit guide vanes 240, 242 having varying configurations, dimensions, and distances from the turbine rotor blades 212, 213.

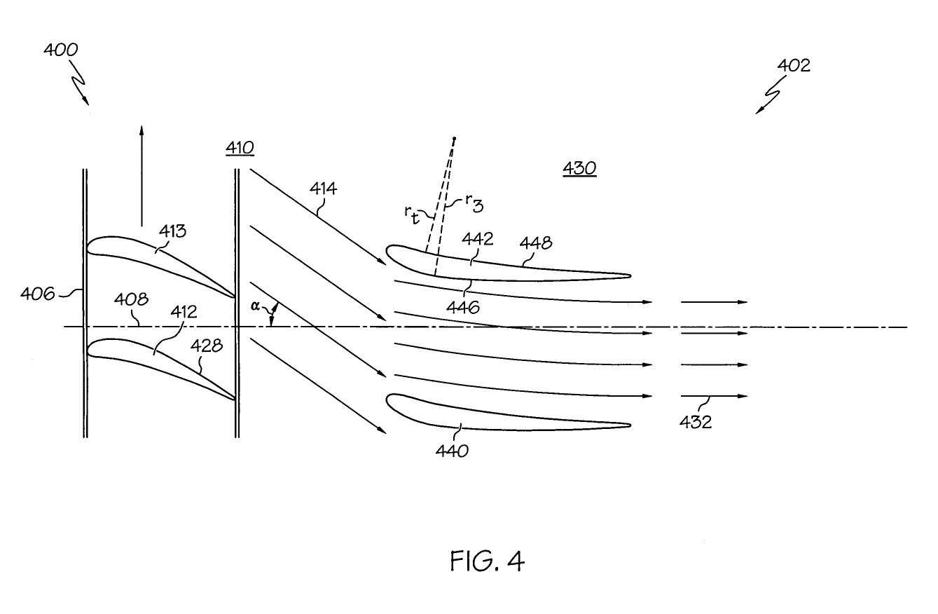

In other embodiments, the overspeed protection mechanism may include additional features to control airflow. FIG. 4 is a simplified, top view taken along line 2-2 in FIG. 1 of an interior of a turbine section 400 and an exhaust section 402 of an engine, according to another embodiment. In this embodiment, the turbine section 400 is similar to the turbine section 200 above and includes a turbine rotor 406 having turbine rotor blades 412, 413 extending therefrom into a turbine section flowpath 410. However, as FIG. 4 illustrates, airflow along the turbine section flowpath 410 may experience swirling when entering the exhaust section 402, which may result from the tangential component of the airflow exiting the turbine rotor 402 in the flow direction 414. Thus, the overspeed protection mechanism in this embodiment may further include a deswirling feature adapted to reduce swirl of the airflow flowing through an exhaust section flowpath 430. As used herein, the term “deswirl” may be defined as the removal of swirl from an airflow so as to cause the airflow to move in a direction that is substantially parallel (e.g., (+0.5°) to a longitudinal axis extending through the engine as shown by flow direction 432.

The deswirler may comprise cambered exit guide vanes 440, 442. Each vane 440, 442 may have a convex, suction side wall 446 and/or a concave, pressure side wall 448, and each wall 446, 448 may have a curvature radius. For example, a curvature radius (r₃) of the suction side wall 446 may be in a range of from about 1 inch (2.54 cm) to about 3 inches (7.62 cm), and a curvature radius (r₄) of the pressure side wall 448 may be in a range of from about 2 inches (5.08 cm) to about 5 inches (12.70 cm). In other embodiments, the curvature radii may be greater or less. Additionally, each cambered exit guide vane 440, 442 may have a varying width along its axial length, or may have a substantially uniform width (e.g., within ±0.5 mm) along its axial length. In an example embodiment, the widths may be within a range of from about 0.050 inch (0.127 cm) to about 0.120 inch (0.305 cm). In other embodiments, the widths may be less or more. In any case, the convex, suction side wall 446 may be aligned such that airflow from the turbine rotor blade 412, 413 may flow directly to the convex, suction side wall 446, during, for example, a normal engine operating condition.

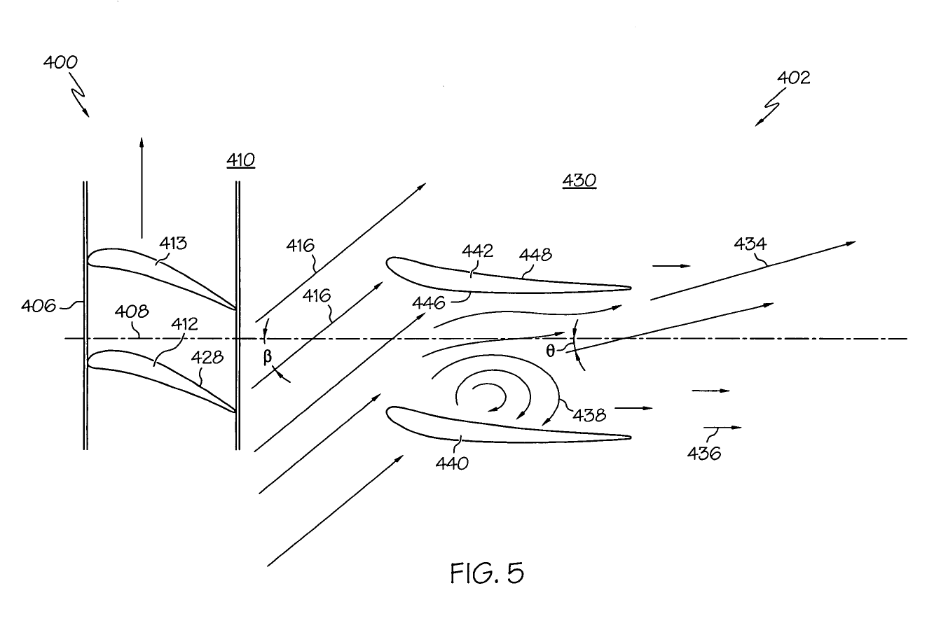

In one embodiment of the overspeed condition, as shown in FIG. 5, airflow flowing along an initial direction vector 416 having a first negative offset angle (“β”) relative to a longitudinal axis 408 impinges the convex, suction side wall 446 of a cambered exit guide vane 440, 442 and is blocked. A first portion of the blocked airflow is re-directed to flow around the flow separation and recirculation 438 along another, swirled air direction vector 434 when exiting the exhaust section 402, where the swirled air direction vector 434 has a second negative angular offset (“σ”) from the longitudinal axis 408 that is smaller than the first negative angular offset (“β”) of the initial direction vector 416. A second portion of the blocked airflow may travel in a circular motion 438 along the concave, pressure side wall 448, where the velocity of the airflow is reduced. The blockage of airflow through the exhaust section resulting from the recirculation 438 and redirection 434, restricts the area available to the airflow resulting in pressure dissipation that reduces energy available to the turbine rotor to thereby limit overspeed. In some cases, the first portion of the blocked airflow may exit the exhaust section 430 by flowing around the second portion. In any case, one or both of the first and second portions of airflow may be deswirled to thereby travel along a deswirled air direction vector 436 that may have a third negative angular offset from the longitudinal axis 408 that is smaller than the first negative angular offset (“β”), that may be unequal to the second negative angular offset (“σ”) and that may be closer to parallel with the longitudinal axis 408 than direction vector 434.

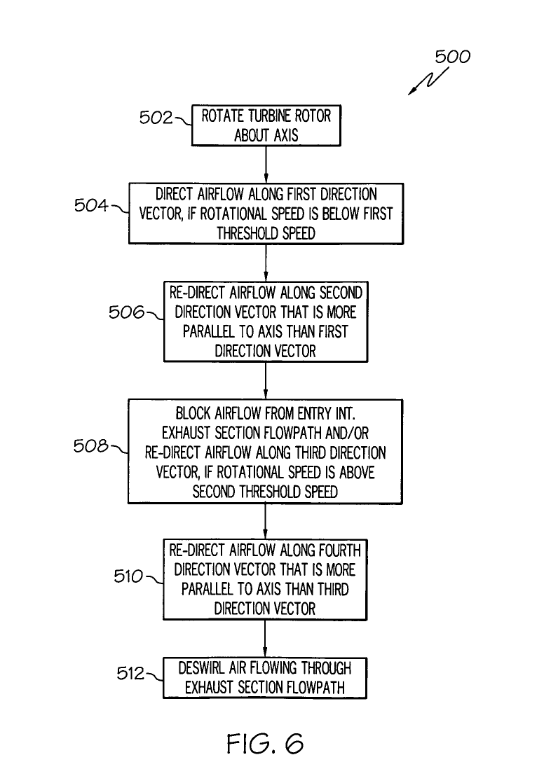

The engine may operate according to a method 500 shown in a flow diagram depicted in FIG. 6, according to an embodiment. A turbine rotor (e.g., turbine rotor 206 of FIG. 2 or 406 of FIG. 4) is rotated at a rotational speed about a longitudinal axis, step 502. Rotation of the turbine rotor may create an airflow. The airflow is then directed through a turbine section flowpath along a first direction vector (e.g., vector 214 in FIG. 2 or vector 414 in FIG. 4) when the turbine rotates below a first threshold speed, wherein the first direction vector has a positive angular offset from the longitudinal axis, step 504. In an embodiment, the first threshold speed is in a range within about 110% of a design speed. However, the first threshold speed may be more or less than the aforementioned range, in other embodiments.

Substantially all of the airflow received from the turbine section flowpath is re-directed such that a majority of airflow received along the first direction vector flows through an exhaust section flowpath along a second direction vector (e.g., vector 232 in FIG. 2 or vector 432 in FIG. 4) that is more parallel to the longitudinal axis than the first direction vector, step 506. In an embodiment, the step of re-directing includes flowing the airflow around a plurality of exit guide vanes (e.g., exit guide vanes 240, 242 in FIG. 2 or 440, 442 in FIG. 4) disposed within the exhaust section flowpath. The plurality of exit guide vanes may be included in an exhaust nozzle assembly that has a center body, where the center body is disposed adjacent the turbine rotor and extends axially through an engine case to define the exhaust section flowpath, and the plurality of exit guide vanes extend radially outwardly from the centerbody. In another embodiment, the second direction vector is substantially parallel to the longitudinal axis.

When the turbine rotates above a second threshold speed, airflow may be directed through the turbine section flowpath along a third direction vector (e.g. vector 216 in FIG. 3 or vector 416 in FIG. 5), where the third direction vector has a first negative angular offset from the longitudinal axis, step 508 and a portion of the area through which the airflow from the turbine section passes before entry into the exhaust section flowpath, is reduced by flow recirculation and redirection resulting in pressure dissipation and reduced torque produced by the turbine. The turbine may rotate above the second threshold speed as a result of an overspeed condition. Thus, the second threshold speed is more than the design speed of the engine. In an embodiment, the second threshold speed may be greater than about 110% of the design speed. In still other embodiments, the second threshold speed may be above 130% of the design speed.

In another embodiment, a portion of airflow received along the third direction vector may be re-directed to flow along a fourth direction vector (e.g., direction vector 234 in FIG. 3 or vector 434 or 436 in FIG. 5) having a second negative angular offset from the longitudinal axis that is closer to parallel with the longitudinal axis than the third direction vector, step 510. In another embodiment, the fourth direction vector may have a second negative angular offset that is smaller than the first negative angular offset of the third direction vector.

In still another embodiment, the method 500 also includes deswirling the airflow flowing through the exhaust section flowpath, step 512. For example, the step of deswirling may comprise flowing the airflow around a plurality of cambered exit guide vanes (e.g., cambered exit guide vanes 440, 442 in FIG. 4) disposed within the exhaust section flowpath. In an embodiment, the airflow enters the space between the cambered exit guide vanes with a positive tangential direction vector and exits the space with a reduced tangential component, essentially an axial direction vector.

By including the overspeed protection mechanism and by operating an engine including the mechanism as described above, the speed of the turbine rotor may be limited under certain circumstances. In particular, by positioning exit guide vanes in the manner described above, at least a portion of the area through which the air flows may be blocked when the turbine rotates above a second threshold speed. This blocked area causes excess pressure in the airflow to dissipate and reduces torque produced by the turbine rotor, thereby limiting the overspeed condition. This may occur, in part, by positioning the exit guide vanes such that an angular difference between a direction along which an airflow travels through the turbine section and a direction along which an airflow travels through the exhaust section is decreased. As a result, a pressure differential between air pressure at a location in the turbine section and air pressure at a location in the exhaust section may be increased as well, as compared to pressure differentials experienced by conventional turboshaft turbine engines. The increased pressure differential acts as a brake, which thereby decreases the turbine rotor speed. Consequently, the magnitude of the overspeed condition is limited. The overspeed protection mechanism may be inexpensively implemented into many types of engines other than turboshaft turbine engines, and may be easily retrofitted into existing engines.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. An engine, comprising:
a turbine rotor adapted to rotate about a longitudinal axis and to at least partially define a turbine section flowpath including the longitudinal axis extending therethrough, wherein the turbine rotor includes a plurality of turbine rotor blades adapted to direct an airflow through the turbine section flowpath along a first direction vector when the turbine rotates below a first threshold speed, and along a second direction vector when the turbine rotates above a second threshold speed, wherein the first direction vector has a positive angular offset from the longitudinal axis, and the second direction vector has a first negative angular offset from the longitudinal axis;
an exhaust section adapted to receive the airflow from the turbine section flowpath, the exhaust section defining an exhaust section flowpath; and
a means for limiting overspeed in flow communication with the turbine section flowpath, wherein the means for limiting overspeed is adapted to block a first portion of the airflow received along the first direction vector from flowing into the exhaust section flowpath and to redirect a second portion of the airflow received along the first direction vector or a portion of the blocked first portion of the airflow to flow along a third direction vector that is closer to parallel with the longitudinal axis than the first direction vector.

2. The engine of claim 1, further comprising:
a deswirling feature disposed in the exhaust section flowpath and adapted to deswirl the airflow flowing therethrough.

3. The engine of claim 2, wherein the deswirling feature comprises a plurality of cambered exit guide vanes disposed within the exhaust section flowpath.

4. The engine of claim 1, further comprising:
a plurality of exit guide vanes that include a deswiling feature disposed in the exhaust section flowpath and adapted to deswirl the airflow flowing therethrough.

5. The engine of claim 1, wherein the means for limiting overspeed comprises a plurality of exit guide vanes extending axially along the exhaust section flowpath.

6. The engine of claim 5, further comprising:
an engine case; and
an exhaust nozzle assembly including a centerbody disposed adjacent the turbine rotor and surrounded at least partially by the engine case to define the exhaust section flowpath,
wherein the plurality of exit guide vanes extends radially outwardly from the centerbody.

7. The engine of claim 5, wherein the plurality of exit guide vanes is spaced substantially uniformly around the longitudinal axis.

8. The engine of claim 1, wherein the means for limiting overspeed comprises a plurality of straight exit guide vanes extending axially along the exhaust section flowpath.

9. The engine of claim 1, wherein the second threshold speed is greater than the first threshold speed.

10. The engine of claim 1, further comprising a primary output component coupled to the turbine rotor.

11. The engine of claim 1, wherein the means for limiting overspeed is further adapted to direct airflow along the third direction vector, wherein the third direction vector is substantially parallel to the longitudinal axis.

12. The engine of claim 1, wherein the means for limiting overspeed comprises a plurality of cambered exit guide vanes extending axially along the exhaust section flowpath.

13. A method of operating an engine, the method comprising the steps of:
rotating a turbine rotor at a rotational speed about a longitudinal axis;
directing an airflow through the turbine section flowpath along a first direction vector when the turbine rotates below a first threshold speed, wherein the first direction vector has a positive angular offset from the longitudinal axis;
re-directing substantially all of the airflow flowing along the first direction vector to flow through an exhaust section flowpath along a second direction vector that is closer to parallel with the longitudinal axis than the first direction vector;
directing an airflow through the turbine section flowpath along a third direction vector when the turbine rotates above a second threshold speed, the third direction vector having a first negative angular offset from the longitudinal axis; and
blocking at least a portion of the airflow flowing along the third direction vector from flowing into the exhaust section flowpath.

14. The method of claim 13, further comprising the step of:
deswirling the airflow flowing through the exhaust section flowpath.

15. The method of claim 13, wherein the step of deswirling comprises flowing the airflow around a plurality of cambered guide vanes disposed within the exhaust section flowpath.

16. The method of claim 13, wherein the step of re-directing substantially all of the airflow comprises flowing the airflow around a plurality of exit guide vanes disposed within the exhaust section flowpath.

17. The method of claim 16, further comprising the step of flowing the airflow through an exhaust nozzle assembly including a centerbody and the plurality of exit guide vanes, the center body disposed adjacent the turbine rotor and extending axially through an engine case to define the exhaust section flowpath, and the plurality of exit guide vanes extending radially outwardly from the centerbody.

18. The method of claim 13, wherein the step of re-directing substantially all of the airflow comprises re-directing substantially all of the airflow to flow through an exhaust section flowpath along the second direction vector, wherein the second direction vector is substantially parallel to the longitudinal axis.

19. The method of claim 13, wherein the second threshold speed is greater than the first threshold speed.
